(19) United States
(12) Patent Application Publication
(10) Pub. No.: US 2024/0051011 A1
(43) Pub. Date: Feb. 15, 2024

(54) Method to manufacture a cable tray component, crimp press to manufacture such cable tray component and cable tray component manufactured therewith

(71) Applicant: OBO Bettermann Produktion Deutschland GmbH & Co. KG, Menden (DE)

(72) Inventors: Wolfang GUTT, Menden (DE); Robert KNOSSALLA, Iserlohn (DE); Andreas MENGE, Menden (DE); Kevin KUTSCHELIS, Hemer (DE)

(21) Appl. No.: 18/549,994

(22) PCT Filed: Apr. 21, 2022
(86) PCT No.: PCT/EP2022/060566

§ 371 Date: Sep. 11, 2023

(30) Foreign Application Priority Data
Apr. 22, 2021 (DE) 10 2021 110 315.0

(51) Int. Cl. B21D 53/36; B21D 22/22; B21D 17/02

(52) U.S. Cl. CPC B21D 53/36; B21D 22/22; B21D 17/02

(57) ABSTRACT

The invention relates to a method for producing a cable tray component which is made of metal and designed, for example, as a cable tray (1) or cable tray cover and has a sequence of beads (5) along its longitudinal extent, which beads are stamped into the workpiece (14) used to form the cable tray component (1) by means of a stamping process, wherein, for the process of bead stamping, the workpiece (14) is clamped in a hold-down element (N) adjacent to or in the transition to a bead (5) to be created. A special feature according to a first embodiment of the method is that the workpiece (14) is held in the hold-down element (N) by a form fit which acts in the radial direction towards the bead (5) to be created and is produced by at least one form-fitting edge (16, 17) pressed into the surface of the workpiece (14), as a result of which at least one indentation following the shape of the bead (5) is introduced into the material of the workpiece (14) by the hold-down element (N) before the bead (5) is formed. According to another embodiment of the method, to create the bead, following its outline geometry, the workpiece in the bead edge region is reduced in terms of its material thickness in the direction of the bead to be created, over a portion extending in the radial direction towards the bead to be created, by at least one stamping bulge located on the hold-down element, and is thus lengthened in the direction of the bead to be formed. The invention also relates to bead presses for producing a cable tray component which is made of metal and has a sequence of beads along its longitudinal extent using this method, and a cable tray component produced therewith.

The invention relates to a method for producing a cable tray component which is made of metal and designed, for example, as a cable tray or cable tray cover and has a sequence of beads along its longitudinal extent, which beads are stamped into the workpiece used to form the cable tray component by means of a stamping process, wherein, for the process of bead stamping, the workpiece is clamped in a hold-down element adjacent to or in the transition to a bead to be created.

Cable tray components are, for example, cable trays and cable tray covers. Such cable trays are connected to one another to build up a cable support system and are used in particular to accommodate cables, which may be electrical cables or glass fiber cables. The cable trays have a bottom and two side beams which follow the longitudinal extent of the cable tray and are formed thereon. Since the aim is to make the cable trays as lightweight as possible, thin-walled sheet metal blanks are used as workpieces for this purpose in order to produce a cable tray from them, typically by stamping/bending processes. To ensure that such a cable tray can withstand the weight loads, the bottom is structured by transverse beads, sometimes also by longitudinal beads. The transverse beads extend transversely to the longitudinal extent of such a cable tray. They extend across substantially the entire width of the bottom and typically terminate a short distance in front of the side beams. The transverse beads are stamped by a bead press into the surface region of a blank—the workpiece—intended for the subsequent bottom of the cable tray, typically with a stamping direction which is directed outward with respect to the receiving volume of the cable tray to be formed.

The problem with the concept of stiffening such a cable tray with transverse beads is that the stamping process introduces stresses into the material and thus into the cable tray. The incorporation of these stresses into the cable tray results in the latter tending to twist (swirl). This is a hindrance to the handling of such cable trays, which can be 1 to 3 m long. Nevertheless, a certain degree of torsional yielding of such a cable tray must be accepted if, for example, transverse beads are to be stamped to reinforce the bottom of such a cable tray component. In order to prevent the extent of such twisting from becoming too great, the depth of such a bead introduced into the workpiece is controlled, and in such a way that it does not exceed a certain level. Typical bead depths are about 0.6 to 1.0 mm when unperforated and 2.5 to 2.8 mm when perforated. The above-mentioned susceptibility to twisting of such cable trays occurs primarily with those cable trays which have a somewhat greater material thickness, for example 1.0-1.2 mm, due to the requested load. Another way of keeping the torsional tendency of such a cable tray as low as possible despite the introduction of transverse beads is to keep the number of beads low in addition to specifying only a low stamping depth. However, a reduced number of transverse beads reduces the load-bearing capacity of such a cable tray. A similar problem also arises when longitudinal beads are introduced, especially if they are designed as a series of beads.

DD 0 152075 discloses a method and a device for bead stamping in metal sheets. In this method, a holding bead is stamped into the workpiece in a first step at a distance from the actual beads to be stamped. The holding beads have, for example, a triangular cross-sectional geometry. Together with partial hold-down elements, the stamping tool parts used to form the holding bead serve to clamp the workpiece for forming the beads. The holding beads with the stamping tools engaging in them are intended to prevent material from flowing in the direction of the bead or beads to be formed. However, the disadvantage of this method is that a complex beading tool is required and that the one or more beads are enclosed by the holding bead. Such a bead introduces stresses into the material. This is undesirable. In many applications, the formation of such a holding bead is not desired for the subsequent use of the beaded workpiece.

DE 36 10 022 A1 describes a further method and apparatus for producing beads in sheet metal. In this prior art, a bead press is used to prevent material from flowing during bead stamping, the cooperating stamping tools of which are provided with a coating that increases the coefficient of static friction. This can be, for example, hard material particles. It is true that such stamping tools can increase the static friction between the workpiece and the hold-down elements. However, if beads are to be formed with a greater force, such an increase in the coefficient of friction is not sufficient to prevent material from flowing on. In addition, the spaces between the hard material particles become clogged, so that the hold-down elements of the bead press have to be cleaned at short intervals to ensure a continuously uniform bead stamping.

There is therefore a desire to provide cable tray components which are not only warp-free or virtually warp-free, but which are also suitable for higher load-bearing capacity without having to use a starting material with a greater material thickness for this purpose, and which can be produced in a process-safe manner.

Thus, the object of the invention is to propose such a method. Furthermore, the object of the invention is to propose a bead press suitable for producing such a cable tray component.

The method-related object is achieved by a generic method mentioned at the beginning, with the features of claim 1 or claim 10.

The object related to the bead press is solved according to the invention by a bead press with the features of claim 14 or 15.

According to the first proposed method-related solution, as a result of the form-fitting edge which delimits the surface region to be formed and is pressed into the surface of the workpiece at least transversely to the longitudinal extent of the cable tray component for the operation of bead stamping, and which results in an indentation in the surface of the workpiece, no stresses, or at least no appreciable stresses, are induced during stamping of the beads in the surface regions of the workpiece which are outside the indentation and thus the form-fitting during the bead stamping. This is achieved by the fact that the hold-down element, or at least one of the cooperating components of the hold-down element, is equipped with at least one form-fitting edge which is pressed into the surface of the workpiece. When the hold-down element is closed, a form fit is thus provided between the hold-down element and the workpiece, which acts in the radial direction towards the bead to be formed, and this before the bead is stamped.

The radial direction referred to in relation to a bead in the context of these embodiments is that which runs transversely to the outline geometry of the bead.

According to the second proposed method-related solution, a portion extending in the radial direction relative to the bead to be produced and following the outline geometry of the bead to be produced is formed with a stamping tool as part of the hold-down element, typically a stamping bulge, effecting material displacement. The material is displaced in the radial direction of the bead to be produced. Thus, in this method, too, an indentation is made in the workpiece following the outline geometry of the bead. The parts of the hold-down element cooperating for this forming are designed to effect a material displacement in the direction of the bead to be produced in such a way that the stamping gap increases in the direction of the bead to be produced in the manner of a funnel. Preferably, the plane of the tool gap is inclined in the direction of the intended positioning direction of the bead. With such an embodiment, it is in principle not necessary to have an additional punch in the stamping tool. In many cases, however, such a punch will be provided, whereby such a punch is primarily assigned a directional function for the direction of stamping of the bead. If such a bead press has a punch, in such a method design the punch is first brought onto the workpiece surface with spring preload before the actual bead-forming material thinning is carried out by material displacement with the hold-down elements and their stamping tools or stamping tool parts.

Regardless of which method is used, this enables transverse beads to be stamped into the bottom of such a cable tray component, for example in the form of a cable tray, not only in a dense sequence along the longitudinal extent of the cable tray component and thus also at a close distance from one another, but above all at a greater stamping depth. This also applies in particular to workpieces for producing such a cable tray component that have a greater material thickness. It is understood that this also applies to workpieces with a relatively low material thickness of 0.5 mm to 0.6 mm. Thus, such a cable tray component can be formed by its structuring alone in such a way that it resists significantly higher stresses. A special feature is that, despite the bead formation, no stresses are introduced into the cable tray component and it can therefore be indicated as at least largely warp-free. The proposed method therefore not only simplifies the producing process of such a cable tray, but also simplifies its use during assembly.

According to an embodiment of this method, the workpiece in which a bead is to be stamped is held by a hold-down element adjacent to the path of movement of the stamping punch. Such a hold-down element comprises two holding elements which can be clamped against each other, typically a workpiece table, against which an adjustable hold-down element acts, with the interposed workpiece, in order to clamp a workpiece. When a hold-down element is referred to in this document, it is located at least on both sides of the surface region of the bead to be stamped, on those sides of the bead which are to be kept free of stress adjacent to the bead. In the case of transverse ribs, these are those sides which point in the longitudinal direction of a cable tray component designed, for example, as a cable tray. In the method, the workpiece is held positively in the hold-down element not only by a conventional frictional or clamping fit, but also in an region adjacent to the bead to be formed as a result of at least one form-fitting edge pressed into the surface of the workpiece for the operation of bead stamping, this form fit being formed in the radial direction relative to the bead to be formed and thus in the transverse direction relative to the tensile stress transmitted to the workpiece by the stamping punch. This form fit effectively prevents material from the workpiece flowing into the bead formation for forming the bead, which material is located outside the form fit when viewed from the direction of the bead. This wedging, which engages in the surface of the workpiece, provides a clear demarcation between the material of the workpiece to be formed for forming the bead and that which is not to be influenced by the forming process. The form fit is typically continuous along the length of the bead to be formed. In this way, only material from that surface region which is located between the mold closures is used and at least partially plastically deformed in the stamping of the bead. This is the surface region from which the bead is formed. Thus, such bead formation, even if carried out in close succession, is possible as a result of the unstamped workpiece region located in the transverse direction relative to the longitudinal extent of the cable tray component. The fact that the material of the workpiece is thinned out when the bead is formed in this way is not a problem, since the stiffening caused by the structural change due to the stamping of the bead compensates for the thinning of the material several times over.

In order to achieve the advantages of the invention, it is already sufficient if a form fit is formed by at least one such indentation between the hold-down element and the region provided for forming the bead on one of the two surfaces of the workpiece. This can be done on that surface of the workpiece which is convexly curved at the transition to the bead to be created. The indentation, adjacent to the surface region to be formed, effectively prevents the tensile stress introduced on this surface side of the workpiece by the stamping process from being induced in the surface region of the workpiece located outside the indentation. An increase in this effect is achieved when such an indentation is formed on both surfaces of the workpiece. In such a case, they are typically in alignment with each other in relation to the central longitudinal plane of the workpiece and opposite each other in relation to the direction of movement of the adjustable hold-down element. It is also possible to have a design in which several form fits are introduced into at least one of the two surfaces of the workpiece by means of corresponding indentations. If, in such an embodiment, the formation of such a form fit with both surfaces of the workpiece is intended, the form fitting edges of the hold-down element can also be arranged offset from one another transversely to the stamping direction, so that the workpiece is held between these form fits in a labyrinthine manner.

The penetration depth of a form-fitting edge to achieve the desired form-fitting need not be particularly high. The depth of indentation should not weaken the workpiece, or at least not significantly. Depending on the material and the thickness of the workpiece, the penetration depth can be up to 20 to 25% of the material thickness, depending on whether the form fit is formed on one or both sides. If a form fit is formed in both sides of the workpiece, the total penetration depth of the two form-fitting edges may well be 35 to 45% of the material thickness. With a workpiece thickness of 0.7 mm, a form fit of 0.05 mm to 0.07 mm, pressed into both surfaces, is sufficient for both sides. Deeper pressing in of the form-fitting means is possible, but is generally not considered necessary.

In a preferred embodiment, such a form-fitting is formed circumferentially around the surface region of the workpiece in which the bead is stamped and not merely in the direction of the cable tray component in which no tensile stress is to be induced, for example in the case of a cable tray in the longitudinal extent thereof, if the beads to be inserted are, for example, transverse beads.

In an embodiment of the invention, it is provided that a narrow rib with an asymmetrical cross-sectional region, which follows the course of the bead and projects from the clamping surface of the hold-down element, serves as the form-fitting edge, the flat leg of the rib pointing in the direction of the stamping punch. The advantage of such a design is that when the hold-down element is closed, a force is initially concentrated on the rib so that it can already be pressed into the material of the workpiece with relatively little force, to such an extent that the surface regions of the hold-down element adjacent thereto can exert the intended clamping force on the workpiece.

According to another embodiment, it is provided that the indentation is made in the workpiece by the hold-down element itself, namely by the at least one stamping tool associated therewith. In such a process design, the stamping tool is also the hold-down element. The stamping process is carried out as a forming process by which the workpiece is thinned out in the transition from the workpiece region not formed in this respect to the bead to be stamped over a certain extent in the transverse direction to the bead to be stamped out and thus the material is elongated in the transverse direction relative to the bead between the stamping tool, namely in the direction towards the bead to be produced. In this embodiment, the stamping tool is also equipped with a form-fitting edge. This provides an indentation and thus also a form fit between the workpiece regions elongated into a bead cavity, so that stresses resulting from the beading are effectively prevented from building up in the bead edge regions. For this purpose, the hold-down element of such a beading tool has at least one stamping bulge formed towards the top of the workpiece, which is bounded by the form-fitting edge on its side facing away from the bead to be stamped with it. According to a preferred embodiment, both cooperating stamping tools have such a stamping bulge. The cooperating stamping tools for producing such a bead by thinning the material over a certain distance in the radial direction relative to the bead are designed in such a way that by the stamping process the material thinning is carried out with a specific direction pointing in the direction in which the bead is formed. This measure can be implemented just by an appropriate design of the co-operating stamping tools, so that the bead is formed solely by this process step. As already mentioned above, a punch can be provided which engages in the bead forming cavity and acts on the surface of the workpiece region between the stamping bulges in order to influence the forming direction of the bead. It is understood that such a punch can also be used for combining the stamping by such a punch with bead stamping by the stamping bulge(s) of the stamping tool described above.

The methods described above can be used to produce cable tray components, for example cable trays, which have transverse beads in the bottom in close proximity to one another. Without introducing significant stresses into the cable tray, such transverse ribs can even have a significant widening of their ends, so that they have a bone-shaped outline geometry in a plan view. As a result of this producing process, the widened end portions can be made more than 50% wider than the portions connecting the ends. This is noteworthy because such cross beading provides stiffening in both the transverse and longitudinal directions of the cable tray. The same advantages also apply if a cable tray cover is to be stiffened as a cable tray component by means of corresponding beads, for example transverse beads. Cable tray covers are subject to a higher degree of risk of warping when stresses are introduced, since the folded side parts have a much lower height compared with the height of the beams. Stiffening of such a cable tray end is sometimes also desired if it is to be walkable.

Due to the producing method described above, the beads can be stamped much deeper, especially if they are designed as transverse beads, with depths of 4 to 5 mm being readily possible for unperforated beads and of 3 to 3.5 mm for perforated beads with a sheet thickness of, for example, 0.7 mm. This information is intended to illustrative and not restrictive.

The invention is described below by means of an example of an embodiment with reference to the accompanying figures. In particular shows

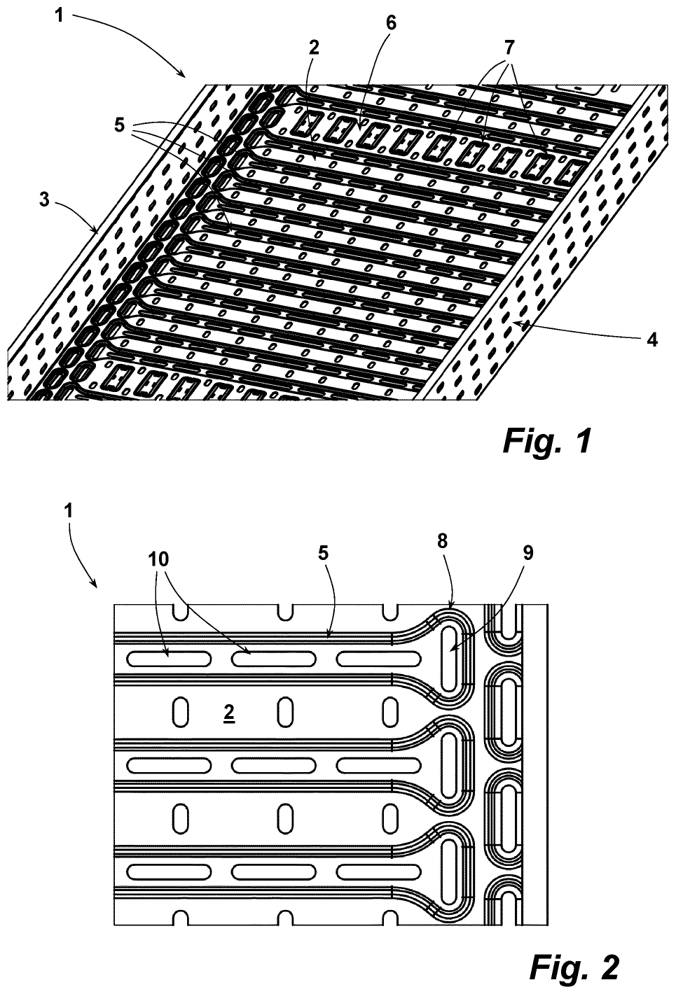

FIG. 1 shows a section of a perspective view of a cable tray component designed as a cable tray,

FIG. 2 shows a top view of a section of the bottom of the cable tray component of FIG. 1,

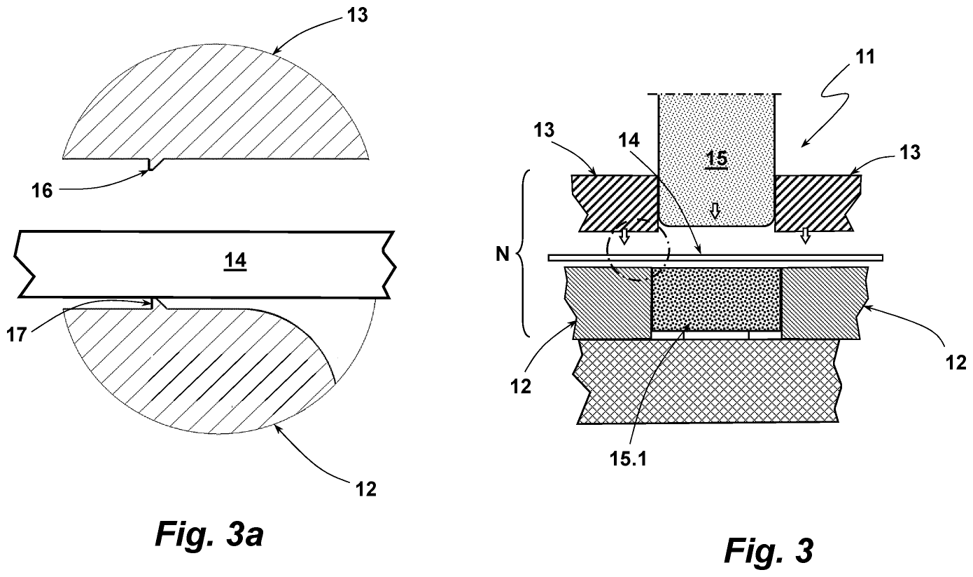

FIG. 3 shows a cross-section through a sheet press shown in its open position according to a first embodiment for producing the transverse beads shown in FIG. 2,

FIG. 3a shows an enlarged detailed view of a section of the cooperating hold-down elements of the bead press of FIG. 3,

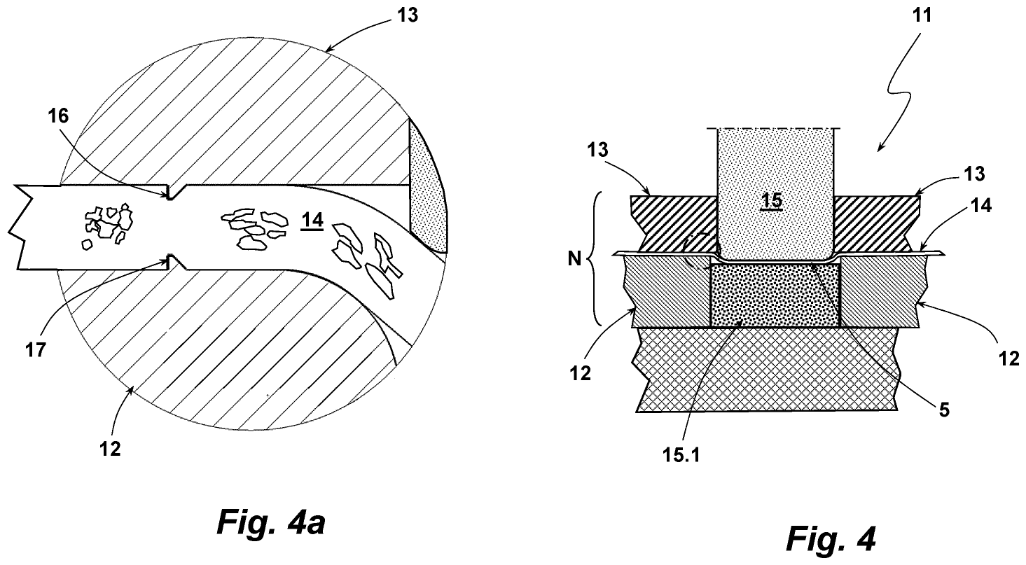

FIG. 4 shows the position of the movable elements of the bead press of FIG. 3 at the end of a bead pressing operation,

FIG. 4a shows an enlarged detailed view of a section of the cooperating hold-down elements of the bead press of FIG. 4,

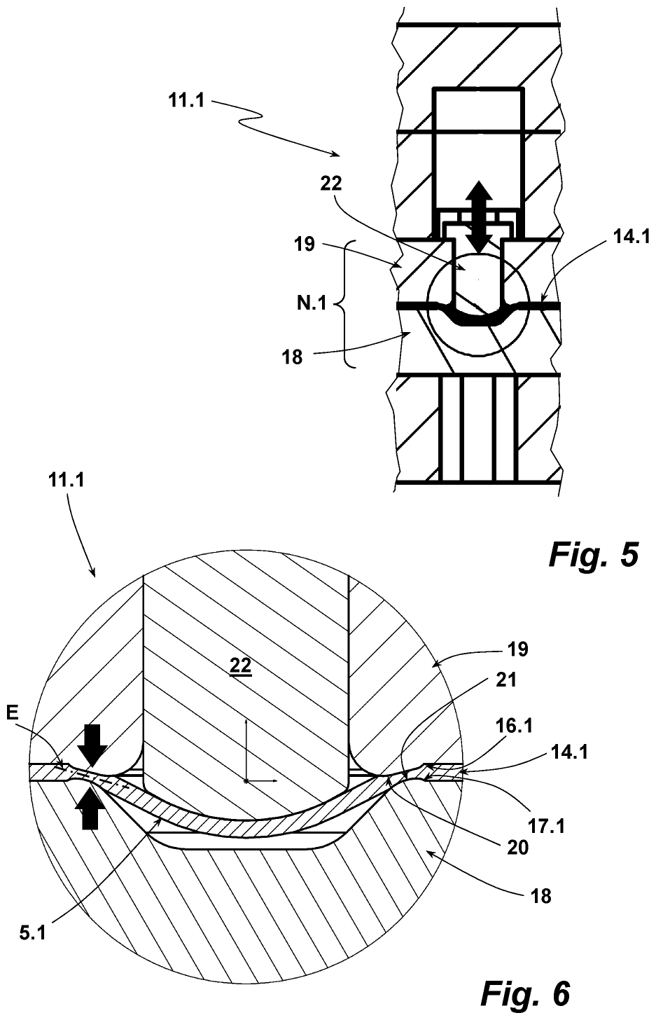

FIG. 5 shows a cross-section through a bead press according to a further embodiment for producing transverse beads shown in FIG. 2,

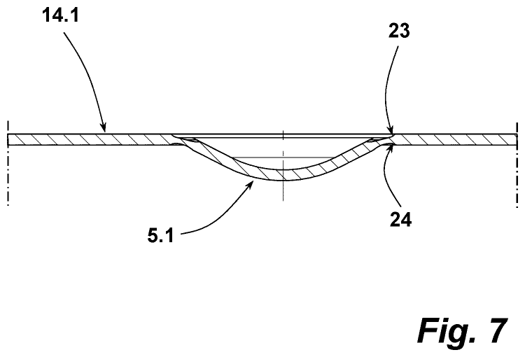

FIG. 6 shows a detailed representation of the bead press of FIG. 5 when forming a bead, and

FIG. 7 shows a cross-section through the bottom of a cable tray in a section with a transverse bead stamped with the bead press of FIGS. 5 and 6.

A cable tray 1, made of a steel material normally used for cable trays, comprises a bottom 2 and two side beams 3, 4 formed thereon. The side beams 3, 4 run in the longitudinal direction of the cable tray 1. A plurality of adjacent bottom beads 5 are stamped into the bottom 2 of the cable tray 1. The shape of the bottom beads is bone-shaped in a plan view due to the bead ends thickening in the longitudinal direction of the cable tray 1. The stamping direction of the bottom beads 5 is directed outwardly thus away from the tray volume enclosed by the bottom 2 and the side beams 3, 4. In the case of the cable tray 1, the transverse bottom beads 5 are grouped into bottom bead groups. Each bottom bead group is separated by a tray section 6 with breakout openings 7. This is repeated along the length of the cable tray 1. In each tray section 6, several break-out openings 7 are arranged in the transverse direction of the cable tray 1. Between each tray section 6 with break-out openings 7 there is a tray section with several bottom beads 5.

The outline geometry of the bottom beads 5 can be seen more clearly in the top view of a section of the bottom 2 of the cable tray 1 in FIG. 2. The cable tray 1 has a perforation made in the bottom 2 according to a grid, which is typical for cable trays. The perforation is used, for example, for fastening purposes. In the cable tray 1, the bottom beads 5, which extend over the entire width of the bottom 2 to the greatest possible extent, have widened end portions 8. In the illustrated embodiment, the extent of the widening of the bottom beads 5 pointing in the longitudinal direction of the cable tray 1 is about 75% wider in their end portions 8 than in the portion connecting the ends. This design of the end portions 8 is used so that an oblong hole pointing in the longitudinal direction of the cable tray 1 can be accommodated in them. The longitudinal extent of the oblong hole 9 thus runs transversely to the longitudinal extent of the oblong holes 10 made in the section of the bottom bead 5 connecting the end portions 8.

A special feature of the cable tray 1 is that the bottom beads 5, as can be seen in particular from the top view of FIG. 2, are virtually directly adjacent to one another with their end portions 8 and are separated from one another only by a short apex at the transition between the end portions 8 of two adjacent bottom beads 5.

Another special feature of the cable tray is that the large number of bottom beads 5 results in an enormous stiffening of the cable tray 1, which is why it has been produced from a comparatively thin sheet metal blank with a material thickness of only 0.5-0.6 mm. This is achieved not only by the close arrangement of the transverse beads 5 along the length of the cable tray 1, but also by the depth of the stamping of the beads. These are stamped with a beading depth of 3-4 mm. This in itself is already special. However, the cable tray 1 is particularly impressive in that, despite the large number of transverse bottom beads 5—so-called cross beads—and the deep stamping depth, the cable tray 1 is stress-free, or at least as good as stress-free. Finally, the bottom beads 5 have been stamped into the bottom 2 of the workpiece from which the cable tray 1 is made, while the side beams 3, 4 are unstamped in the longitudinal extent of the cable tray 1.

This is achieved by stamping the bottom beads 5 of the cable tray 1 into the workpiece after a form fit with the surface of the workpiece has been created between the hold-down element of a bead press and the workpiece adjacent to the surface region of the bead to be stamped. In the embodiment shown, the form fit is formed continuously around the entire outline of a bottom bead 5. In the embodiment shown, the form fit is formed on both flat sides of a workpiece.

A bead press 11 shown schematically in FIG. 3 is used to produce the bottom beads 5. Only a section of the bead press 11 is shown in FIG. 3. The bead press 11 has a number of bead press units corresponding to the number of bottom beads 5 to be formed in a section, so that these can be formed together in one press stroke. The individual segments of the bead press 11 correspond to the structure described below on the basis of the section of the bead press of FIGS. 3 and 3a. The bead press 11 has a hold-down element N, formed by a tool table 12 and a clamping jaw 13 movable relative thereto. This hold-down element N fixes the blank-like workpiece 14 for the process of stamping a bottom layer 5. The bead press 11 is shown in its open position in FIG. 3. Only after the workpiece 14 has been fixed by the hold-down element N is the desired bead outline stamped into the workpiece 14 with a stamping punch 15. FIG. 3a shows a detail of the hold-down element N, formed by the tool table 12 and the clamping jaw 13. The clamping jaw 13 and the underside of the tool table 12 each have a form-fitting edge 16, 17 in the form of a pinch edge, which reduces the width of the clamping gap between the tool table 12 and the clamping jaw 13. The form fit acts in the transverse direction and thus in the radial direction to the bead to be stamped or towards the stamping punch 15.

In this exemplary embodiment, the form-fitting edges 16, 17 are provided by a circumferential rib of asymmetrical cross-section. The flank with the lower inclination relative to the usual clamping surface of tool table 12 and clamping jaw 13 points in the direction of the stamping punch 15 of the bead press 11, which is not shown in this figure. Thus, the steeper flank points in the opposite direction. This flank is responsible for the formation of the form fit described above and acts as an abutment when pressed into the upper sides of the workpiece 14. An embodiment of a hold-down element N, as described with respect to the bead press 11, can be pressed into the surface of a workpiece with very little force, since a concentration of force takes place due to the rib-like form fitting edges 16, 17.

The form fit effectively prevents material of the workpiece 14, which is located outside the form-fitting edges 16, 17, from being drawn into the formation of the bottom bead (transverse bead) to any appreciable extent during the subsequent stamping of a bottom bead 5. Consequently, no tensile stress, or at least no appreciable tensile stress, is induced in the regions located outside the form-fitting edges 16, 17. In any case, the stamping of the form-fitting edges 16, 17 effectively prevents the material of the workpiece 14 which is close to the surface from flowing in. This is due to the fact that the regions of the workpiece 14 outside the form-fitting edges 16, 17 are not subject to stress, since there can be no flow in the opposite regions of the workpiece 14 close to the surface. This means that only material from the surface region of the workpiece 14 located within the circumferential form edges 16, 17 is used to form the bottom bead 5. The formation of the bottom bead 5 is accompanied by a thinning of the material, but this does not impair the torsional stiffness and load-bearing capacity of the cable tray 1.

In the bead press 11, the punch 15 cooperates with an extractor 15.1. The extractor 15.1 is located inside the tool table 12, which is designed as a lower hold-down element.

FIG. 4 shows the bead press 11 after performing a bead press stroke to form a bottom bead 5 in the workpiece 14, which forms the bottom 2 of the cable tray 1. To form the bead 5, the workpiece 14 has first been clamped in the hold-down element N formed by the tool table 12 and the clamping jaw 13. In the course of this clamping process, the form-fitting edges 16, 17 have been pressed into the opposing surfaces of the workpiece 14 (see also FIG. 4a). The workpiece 14 is clamped with the other surfaces of the hold-down element N facing each other. Only after the workpiece 14 has been clamped in the hold-down element N in this way and the desired form fit in the radial direction to the bead 5 to be produced has been formed, does the actual forming of the bottom bead 5 take place with the punch 15, which presses the material of the workpiece 14 into the die formed by the workpiece table 12 and the extractor 15.1 received therein. In the course of forming the bead 5 and pressing the surface region of the workpiece 14 forming the bead 5 into the punch in the manner of deep drawing, grain elongation takes place in the regions of plastic deformation. These are the regions in which material thinning can be observed. A subsequent flow of material from outside the form-fitting edges 16, 17 is effectively prevented by the form-fit. For this reason, the regions outside the bead 5 are stress-free.

In the schematic enlargement of FIG. 4a, the elongation of the grains associated with the formation of the bottom bead 5 is shown schematically and greatly enlarged. It can be seen that the grains have their typical globular shape due to the previous producing process outside the form fit caused by the form-fitting edges 16, 17. If the workpiece is rolled, these grains can also have an oblong shape. The grains are most elongated by the beading in those regions where the punch 15 acts on the workpiece 14.

FIG. 5 shows a further bead press 11.1, in which the transverse bead of a cable tray to be produced is formed according to a different principle. For the bead press 11.1, the same components as for the bead press 11 are marked with the same reference numerals, supplemented by the suffix “0.1”. The design of the bead press 11.1 is better illustrated in detail in FIG. 6.

Instead of a basically flat tool table 12 and a clamping jaw 13, the bead press 11.1 has two cooperating stamping tools 18, 19. These are each part of a hold-down element N.1. The lower stamping tool 18, since it is stationary, can certainly be referred to as a tool table. The stamping tools 18, 19 can be moved against each other, as indicated by the block arrows in FIG. 6. In the exemplary embodiment shown, the stamping tools 18, 19 each have a stamping bulge 20, 21 running around the bead 5.1 to be stamped, which bulge 20, 21 acts in the direction away from the bead 5.1 to be formed, forming a form-fitting edge 16.1, 17.1. The regions of the workpiece 14.1 outside the form-fitting edges 16.1, 17.1 are held between the hold-down elements. The gap width between the stamping tools 18, 19 is therefore greater outside the form-fitting edges 16.1, 17.1 than between the stamping bulges 20, 21. The geometry of the stamping gap between the stamping bulges 20, 21 is enlarged in the shape of a funnel in the direction towards the bead 5.1 to be stamped. The plane of the stamping gap, indicated in FIG. 6 by the reference sign E, is inclined relative to the horizontal plane of the workpiece 14.1 in the direction of the bead 5.1 to be formed. The effect is that the material of the workpiece 14.1 bounding the bead 5.1 is plastically deformed by a press stroke and displaced in the direction of the bead 5.1 to be formed (see FIG. 6). In the case of the bead press 11.1, the radially extending length of the stamping gap defines the width of the portion of the workpiece 14.1 subjected to material displacement. These stamping tools 18, 19 with their stamping bulges 20, 21 thus not only provide a form-fitting edge 16.1, 17.1, but also cause the bead 5.1 to be formed. The thinning of the material leads to an elongation of the workpiece section which is gripped by the stamping bulges 20, 21 or on which they act. A punch 22 acts in this region, which is located in the tool in a bead forming cavity 23, on that upper side of the workpiece 14.1 which faces away from the desired stamping direction. The stamping direction is thus specified by the punch 22 within the bead cavity. The punch 22 is spring-loaded and is brought into contact with the upper side of the workpiece 14.1 before the stamping stroke for forming the bead 5.1 is performed by the cooperating stamping bulges 20, 21. The bead stamping stroke is limited by an abutment and ends when the hold-down element N.1 comes to rest with its regions adjacent to the stamping bulges 20, 21—its clamping portions—on the respective upper surface of the workpiece 14.1.

In this exemplary embodiment of the bead press 11.1, the material in the starting region of the bead 5 to be stamped out is thinned out by material displacement and thus deformed. The grain elongation in this region is more pronounced due to the stamping on both sides and the significantly induced material thinning than when a bead is created with the bead press 11.

Particularly if the stamping depth of the beads is to be relatively large, this should preferably be carried out with a bead press in accordance with the bead press 11.1. Material thinning for providing the indentation in the workpiece surface is carried out by pressing in the stamping bulges 20, 21 with the result of material displacement. In the case of the bead press 11 and the method carried out with this bead press 11, the maximum forming depth of a bead depends on the yield strength of the workpiece. Forming a bead beyond the yield point of the workpiece is possible due to the material displacement with the method described for the bead press 11.1. Greater bead depths can also be achieved with the bead press 11 if the beads are perforated. If, on the other hand, these are formed with a bead press 11.1, the same bead depth can be achieved without the need for perforation of the beads.

The cross-sectional view in FIG. 7 shows the bottom bead 5.1, which is stamped into the workpiece 14.1 by the bead press 11.1. The peripheral characteristic edges 23, 24 formed by the stamping bulges 20, 21 on the top and bottom of the workpiece 14.1 can be clearly seen.

By means of the bead presses 11 or 11.1 described above, the bottom beads 5, 5.1 produced thereby obtain a circumferential groove (in the case of the bead press 11) or a circumferential edge (in the case of the beading tool 11.1) recognizable on the cable tray 1.

The invention has been described with reference to exemplary embodiments. Without departing from the scope of the applicable claims, there are numerous further possibilities for a person skilled in the art to implement the same without this having to be explained in more detail within the scope of the present disclosure.

### LIST OF REFERENCE NUMERALS

1 cable tray
2 bottom
3 side beam
4 side beam
5, 5.1 bottom bead
6 section
7 breakout opening
8 end portion
9 oblong hole
10 oblong hole
11, 11.1 bead press
12 tool table
13 clamping jaw
14 workpiece
15 stamping punch
15.1 ejector
16, 16.1 form-fitting edge
17, 17.1 form-fitting edge
18 stamping tool
19 stamping tool
20 stamping bulge
21 stamping bulge
22 punch
23 edge
24 edge
E plane
N, N.1 hold-down element

1. A method for producing a cable tray component which is made of metal and designed, for example, as a cable tray (1) or cable tray cover and has a sequence of beads (5) along its longitudinal extent, which beads are stamped into the workpiece (14) used to form the cable tray component (1) by means of a stamping process, wherein, for the process of bead stamping, the workpiece (14) is clamped in a hold-down element (N) adjacent to or in the transition to a bead (5) to be created, characterized in that the workpiece (14) is held in the hold-down element (N) by a form fit which acts in the radial direction towards the bead (5) to be created and is produced by at least one form-fitting edge (16, 17) pressed into the surface of the workpiece (14), as a result of which at least one indentation following the shape of the bead (5) is introduced into the material of the workpiece (14, 14.1) by the hold-down element (N) before the bead (5) is formed.

2. The method according to claim 1, characterized in that the stamping is formed circumferentially around the surface region of the workpiece (14) into which the bead (5) is stamped.

3. The method according to claim 1 or 2, characterized in that the stamping is formed by the stamping tool (19) or the stamping tool part (13) and the workpiece (14) on that surface of the workpiece (14) which is convexly curved at the transition thereto during the process of stamping the bead (5).

4. The method according to claim 1 or 2, characterized in that the stamping is formed by the stamping tool (18, 19) or the stamping tool part (12, 13) and the workpiece (14) on both surfaces of the workpiece (14).

5. The method according to any one of claims 1-4, characterized in that the at least one form-fitting edge (16, 17) projects from the rest of the clamping surface of the hold-down element (N) with an asymmetrical cross-sectional region.

6. The method according to any one of claims 1 to 4, characterized in that the bead forming is carried out with at least one stamping tool (18, 19) with a respective stamping bulge (20, 21), with which the bead edge region is reduced in terms of its material thickness by deformation and is lengthened in the direction of the bead to be formed.

7. The method according to claim 6, characterized in that, between the stamping tools (18, 19), a punch (22) acts on the workpiece region located between the stamping regions with its form-fitting edge (16, 17; 16.1, 17.1) in the direction in which the stamping of the bead (5.1) is to be produced.

8. The method according to any one of claims 1 to 7, characterized in that the indentation produced to form the form fit between the hold-down element (N) and the workpiece (14, 14.1) is formed with a penetration depth which corresponds to at least 5% of the material thickness of the workpiece (14, 14.1).

9. The method according to claim 8, characterized in that the indentation produced to form the form fit between the hold-down element (N) and the workpiece (14, 14.1) is formed with a penetration depth which corresponds, on each side of the workpiece, at most to 20 to 25% of the material thickness of the workpiece (14, 14.1).

10. A method for producing a cable tray component which is made of metal and designed, for example, as a cable tray or cable tray cover and has a sequence of beads (5.1) along its longitudinal extent, which beads are stamped into the workpiece (14.1) used to form the cable tray component by means of a stamping process, wherein, for the process of bead stamping, the workpiece (14.1) is clamped in a hold-down element (N.1) adjacent to or in the transition to a bead (5.1) to be created, characterized in that, to create the bead (5.1), following its outline geometry, the workpiece (14.1) in the bead edge region is reduced in terms of its material thickness in the direction of the bead (5.1) to be created, over a portion extending in the radial direction towards the bead (5.1) to be created, by at least one stamping bulge (20, 21) located on the hold-down element, and is thus lengthened in the direction of the bead (5.1) to be formed.

11. The method according to claim 10, characterized in that the stamping stroke for forming the bead (5.1) is limited by the abutment against the clamping surfaces of the hold-down element (N.1).

12. The method according to one of the claims 1 to 11, characterized in that a plurality of form fits, which are produced by a respective form-fitting edge, which act in the direction of the bead to be produced, which are spaced apart in the radial direction with respect to the bead to be produced and which act in the radial direction with respect to the bead to be produced, are formed.

13. The method according to claim 12, characterized in that a plurality of indentations are introduced in both workpiece surfaces by the hold-down element, which indentations are arranged offset from one another in the radial direction with respect to the bead to be produced.

14. A bead press for producing a cable tray component (1) made of metal, with a sequence of beads (5) along its longitudinal extent, by the method according to any one of claims 1 to 9, characterized in that the bead press (11) has as hold-down element a stamping tool or a stamping tool part (12, 13) with a respective form-fitting edge (16, 17) for forming an indentation in the workpiece (14, 14.1) engaging in the surface of the workpiece (14), for forming a form fit, acting in the radial direction relative to the bead (5, 5.1) to be produced, between the hold-down element (N) and the workpiece (4, 4.1) for the process of bead stamping.

15. A bead press for producing a cable tray component made of metal with a sequence of beads (5.1) along its longitudinal extent, by the method according to claim 10 or 11, characterized in that the hold-down element (N.1) is provided with at least one stamping bulge (20, 21), by means of which, in the course of a stamping stroke, a portion extending in the radial direction relative to the bead (5.1) to be produced is reduced in terms of its material thickness in the direction of the bead (5.1) to be produced and as a result of which an indentation is formed in the workpiece (14.1).

16. The bead press according to claim 15, characterized in that the stamping gap delimited by the at least one stamping bulge (20, 21) increases in a funnel-like manner in the direction of the bead (5.1) to be produced.

17. The bead press according to claim 15 or 16, characterized in that both cooperating parts (18, 19) of the hold-down element (N.1) have a stamping bulge (20, 21).

18. The bead press according to any one of the claims 14 to 17, characterized in that the single means or plural means for creating the indentation in the workpiece (14, 14.1) are arranged circumferentially around the surface region in which a bead (5, 5.1) is to be stamped.

19. A cable tray component produced by the method according to one or more of claims 1 to 13, characterized in that the cable tray component is a cable tray (1) in the bottom (2) of which a sequence of transverse beads (5, 5.1) is stamped with their longitudinal extent transverse to the longitudinal extent of the cable tray (1).

20. The cable tray component according to claim 19, characterized in that the sequence of beads is subdivided into a plurality of transverse bead sectors, each having a plurality of transverse beads arranged directly adjacent to one another, wherein two transverse bead sectors are spaced apart by a differently structured sector, for example a sector with break-out bushings.

21. The cable tray component according to claim 19 or 20, characterized in that the transverse beads (5, 5.1) have at their ends a widening in the longitudinal extent of the cable tray, by means of which such a transverse bead is widened in its end portions (8) by at least 50% with respect to the bead portion connecting the ends.
